(19) United States
(12) Patent Application Publication
(10) Pub. No.: US 2002/0156645 A1
(43) Pub. Date: Oct. 24, 2002

(54) Network-based solution for secure parcel delivery and pick-up

(76) Inventor: Paul E. Hansen, Onalaska, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 10/062,964

(22) Filed: Jan. 31, 2002

Related U.S. Application Data
(60) Provisional application No. 60/265,367, filed on Jan. 31, 2001.

(51) Int. Cl. G06F 17/60

(52) U.S. Cl. 705/1; 705/26

(57) ABSTRACT

Disclosed herein is a secure parcel delivery method and system that provides a bridge between delivery companies and consumers. The solution includes a parcel delivery and pick-up kiosk that serves as a secure delivery and retrieval location for items that have been ordered via, for instance, the Internet, a catalog, mail order systems, or from television retailers. The kiosk is typically a free-standing unit having a metal frame designed to retain and support a plurality of personalized parcel compartments that can vary in size and shape as desired. The kiosk can be electronically connected to a computer, the computer for use in storing, manipulating and retrieving both parcel recipient pertinent information and parcel delivery tracking information. The system includes a central data system for receiving the parcel recipient pertinent information and parcel delivery tracking information to ensure that the kiosk is accessed only by an authorized user of the (e.g., a delivery person, a parcel recipient). The parcel delivery system permits interaction between a delivery service, a parcel recipient and a specified website to solve the “last mile” delivery problem.

### CROSS-REFERENCE TO RELATED APPLICATION

This application claims the benefit of U.S. Provisional Application No. 60/265,367 filed Jan. 31, 2001.

### FIELD AND BACKGROUND OF THE INVENTION

The present invention relates generally to shipping, delivery and storage of goods. In one aspect, the invention relates to the secure holding of goods for shipping and/or delivery. In another aspect, the invention relates to a personalized and automated system for holding goods during delivery and/or pick-up. In still another aspect, the invention relates to an automated, personalized parcel storage method and system, the system and method using a communications network, such as the Internet.

Parcels, which are items, products or goods that are wrapped or packaged, are typically shipped to a specific recipient (e.g., an individual, group of individuals, or organization). Historically, to achieve the appropriate level of delivery “personalization” (i.e., delivery to the specific and appropriate individual, group, or organization), parcels have been delivered to both residential and commercial addresses via a “door-to-door” delivery method or system. In other words, parcel delivery has generally been provided during weekdays, and more specifically, during a set time period (for example, from 9 a.m. to 5 p.m.).

Door-to-door delivery methods or systems such as the above-described have typically required an individual to be present to successfully complete the delivery. In such cases, the individual signs for, so as to verify receipt of, the parcel. Unfortunately, the signing individual is often absent. When this is the case, delivery companies (or the United States Postal Service) have typically instituted procedures to hold packages/parcels, and then at some later time, attempt to deliver the package(s) again. After a certain number of failed attempts to deliver the package, the parcel has typically been returned to some central distribution center for later pick-up by the specific recipient (or perhaps, later delivery by the company or service). Alternatively, parcels have frequently been left at the specified delivery location without having been signed for.

Delivery problems of the kind described above (often referred to as “last mile” delivery problems) have resulted in the packages being left in an unsecured, or otherwise unguarded, fashion. Further, since the package has not been signed for, authorized or appropriate receipt of the parcel has not been verified or otherwise confirmed. Indeed, the above-described delivery system has caused inconvenience, inefficiency, and ultimately, greater cost to both individual customers and delivery companies.

Another delivery solution has been for individuals to purchase personal parcel storage lockers or boxes for placement at their homes at some secure location, for example, in a garage. These lockers have permitted delivery of the parcel to the appropriate destination in a secured fashion at times when a receiving individual was not physically present to verify its delivery. Here, however, a receiving individual typically has to provide delivery service personnel with access to the otherwise “secure” location to deliver the parcel. This, in effect, has compromised the security of the location by permitting delivery personnel to enter and deliver the parcel. For example, delivery personnel may leave the location unlocked or open. In addition, personal parcel lockers have typically been cumbersome and relatively expensive.

As populations increase, so too does the need and demand for goods increase. The recent explosion in “electronic commerce,” or the purchasing and selling of (or in general, transacting for) goods over the Internet via the World Wide Web, is but one example of this increase in the demand for goods.

The Internet is accurately described as a “network of networks.” Computer networks are interconnected individual computers that share information. Anytime two or more computer networks connect, they form an “internet.” The “Internet” is a shorthand name for the vast collection of interconnected computer networks that evolved from the Advanced Research Projects Agency Network (ARPANet) developed by the United States Defense Department in the 1960's and 1970's. Today, the Internet spans the globe and connects hundreds of thousands of independent networks.

The World Wide Web (i.e., the “Web” or “www”) is often mistakenly referred to as the Internet. However, the two are quite different. The Internet is the physical infrastructure of the online world: the servers, computers, fiber-optic cables and routers through which data is shared online. The Web is data: a vast collection of documents containing text, visual images, audio clips, and other information media that is accessed through the Internet. Computers known as “servers” store these documents and make them available over the Internet through “TCP/IP” (Transmission Control Protocol/Internet Protocol), a set of standard operating and transmission protocols that structure the Web's operation. Every document has a unique “URL” (Universal Resource Locator) that identifies its physical location in the Internet's infrastructure. Users access documents by sending request messages to the servers that store the documents. When a server receives a user's request (e.g., for the home page of Amazon.com), the server prepares the document and then transmits the information back to the user.

Indeed, more and more individuals and companies have come to realize the efficiencies associated with electronic commerce (or “e-commerce”) and that e-commerce can be utilized to meet their collective and increasing need for products. Internet-based retailers (also known as “e-tailers”), and their customers who purchase goods using the Internet rely heavily on the direct delivery of those goods. However, significant barriers exist to the success and profitability of such e-tailers (and to companies in general), barriers that are specifically associated with the parcel delivery.

Accordingly, a personalized, secure, convenient, cost-effective, and efficient parcel delivery apparatus, method and system is of tremendous interest to the shipping and delivery industries, to companies, such as traditional retailers as well as e-tailers, and to individual consumers.

### SUMMARY

In accordance with one aspect of the present invention, disclosed herein is an internet-based system for parcel delivery and pick-up, the system comprising: a parcel recipient accessible computer from which a parcel recipient can access over an internet a website to initiate a parcel delivery via a product order; a kiosk located at a parcel delivery and pick-up location, the kiosk capable of storing the parcel, the kiosk electronically connected to a computer, the computer for use in storing, manipulating and retrieving both parcel recipient pertinent information and parcel delivery tracking information; and a central data system for receiving the parcel recipient pertinent information and parcel delivery tracking information from the computer connected to the kiosk and, based on that information, transmitting parcel related data to at least one of the delivery service, the parcel recipient and the website; wherein the parcel can be delivered to the kiosk using the delivery service and the parcel can be picked-up by the parcel recipient.

In accordance with another aspect of the invention, disclosed herein is a method of ensuring authorized parcel delivery and retrieval from a secure location, the method comprising: assigning and storing parcel recipient pertinent information, secure location information, and parcel tracking information; using the parcel tracking information for delivering of a parcel to the secure location ; using the parcel recipient pertinent information for retrieving the parcel at the secure location; and using the stored parcel recipient pertinent information, secure location information, and parcel tracking information so as to monitor, via a computer network, the delivering and retrieving of the parcel thereby ensuring authorized parcel delivery and retrieval from the secure location.

These and other aspects of the present invention will be disclosed below in the drawings, the detailed description, and the appended claims.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. Like reference numerals are used to indicate like components.

FIG. 1A illustrates a front, elevational view of a kiosk in accordance with the present invention.

FIG. 1B illustrates a right side, elevational view of the kiosk of FIG. 1A in accordance with the present invention.

FIG. 1C illustrates a rear, elevational view of the kiosk of FIG. 1A in accordance with the present invention.

FIG. 1D illustrates a left side, elevational view of the kiosk of FIG. 1A in accordance with the present invention.

FIG. 2 illustrates a side view of a kiosk for use in the present invention wherein the kiosk has been artfully decorated.

FIG. 3 illustrates a perspective view of the a kiosk in accordance with one aspect of the present invention.

FIG. 4 illustrates a flow diagram for establishing a customer account in accordance with one aspect of the present invention.

FIG. 5 illustrates a flow diagram for providing delivery of a parcel in accordance with one aspect of the present invention.

FIG. 6 illustrates a flow diagram for retrieval of a delivered parcel in accordance with one aspect of the present invention.

FIG. 7 illustrates a flow diagram for tracking a parcel in accordance with one aspect of the present invention.

FIGS. 8-10 illustrate various screen user interfaces used in delivery and pick-up aspects of the present invention.

FIG. 11 is a schematic diagram of one embodiment of a parcel delivery and pick-up solution according to the present invention.

### DETAILED DESCRIPTION OF THE PREFERRED EMBODIMENT

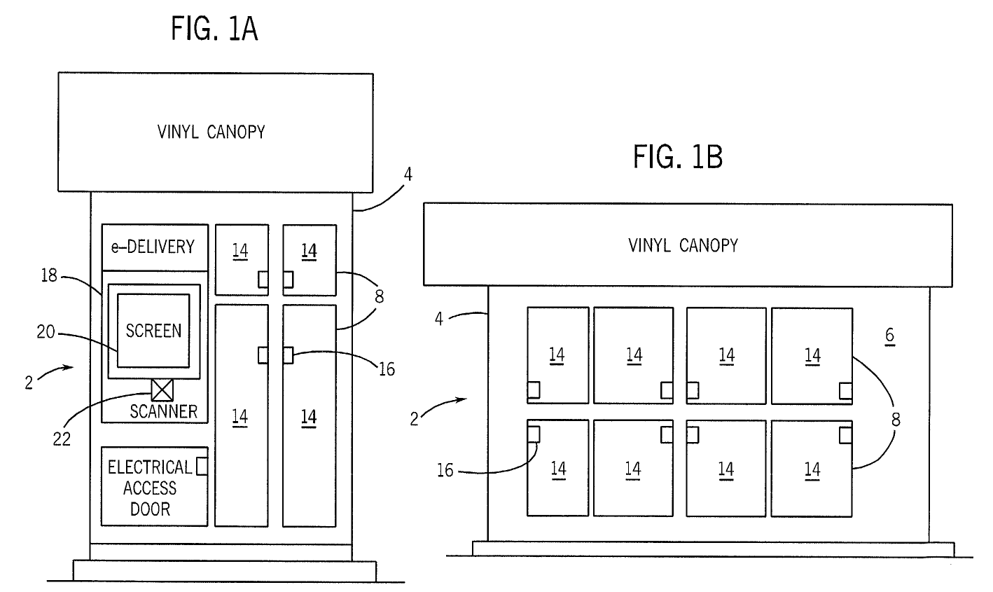

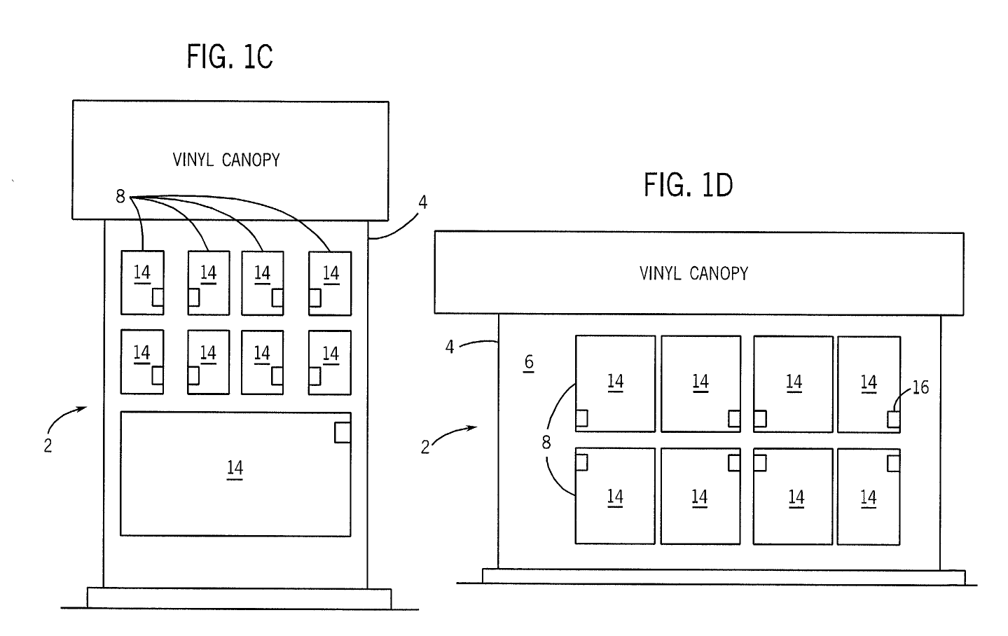

In FIG. 1A-1D, an embodiment of a parcel kiosk 2 for use with a novel system and method is illustrated. Kiosk 2 is designed to provide a secure parcel delivery, storage, and pick-up solution to a variety of users. Such users are contemplated to be individual consumers, corporate consumers, delivery companies (e.g., United Parcel Service, Federal Express, United States Post Office, etc.), retailers (e.g., Best Buy, Sears, Wal-Mart, etc.), and Internet retailers or “e-tailers” (e.g., Amazon.com, etc.). Since retailers and “e-tailers” typically have their products delivered by a delivery company to a consumer's residence or place of business, kiosk 2 can provide a valuable conduit through which consumers, delivery companies, retailers, and e-tailers harmoniously conduct business transactions.

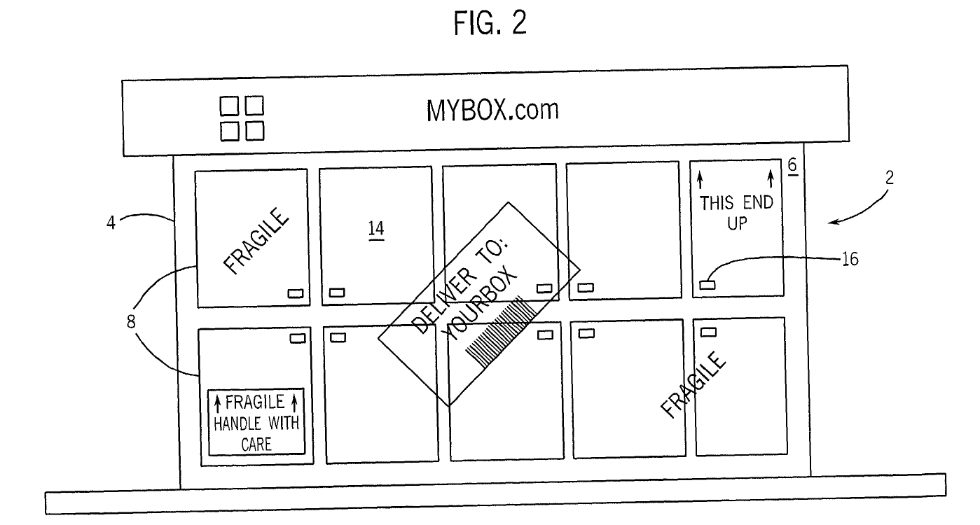

Kiosk 2 comprises a structural skeleton 4. Skeleton 4 provides the necessary framework to permit kiosk 2 to be a free-standing unit. Typically, skeleton 4 comprises steel that has been wrapped in an insulating material 6, such as a layer of twelve-gauge (12) metal. In preferred embodiments, skeleton 4 can include a baked-on layer of enamel finish to provide protection from the elements (e.g., rain, sleet, snow, wind, etc.). As such, kiosk 2 may be used in both indoor and outdoor applications. As shown in FIG. 2, kiosk 2 can be artfully decorated to provide the kiosk with an aesthetically pleasing facade or veneer.

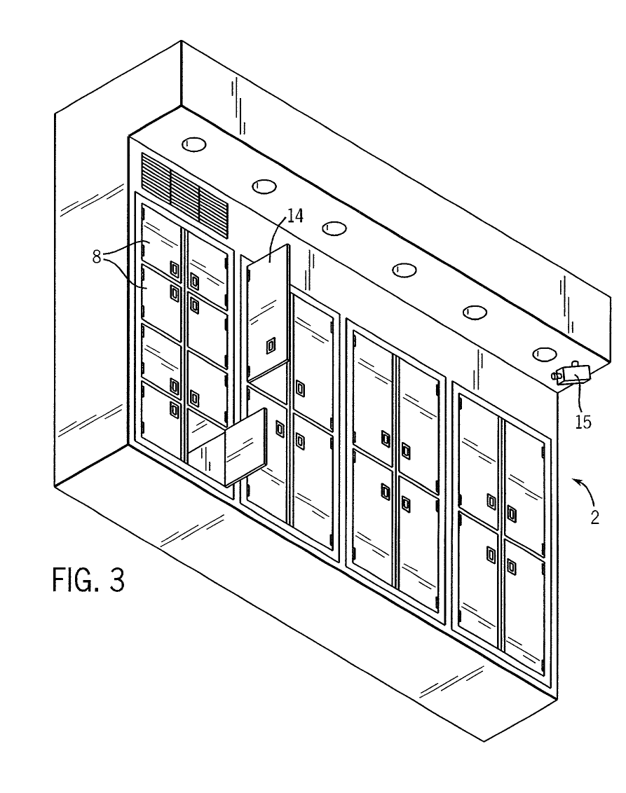

As shown in FIG. 3, kiosk 2 is configured to slidably support a plurality of parcel compartments 8, (also called a “kiosk box”, “kiosk lock-box”, a “locker”, and the like). Parcel compartment 8 can vary in size, shape, and geometry. Typically, parcel compartments 8 are constructed of a sturdy material, such as stainless steel. Each parcel compartment 8 slidably advances and retreats within the kiosk in a fashion similar to the sliding of a dresser drawer or a bank safety deposit box. Each compartment 8 can include a door 14 which can be opened to access the interior of the compartment and to permit deposit of a parcel therein.

Referring back to FIG. 1A-1D, doors 14 cover, alone or in combination, one or more parcel compartments 8. Doors 14 permit parcel compartments 8 to be selectively opened and closed and can be fitted (or retro-fitted as the case may be) with an electronic locking and releasing system 16 (shown schematically). Doors 14 are preferably constructed of stainless steel and covered with a baked-on enamel finish. As shown in FIGS. 2 and 3, doors 14 can be artfully decorated. Doors 14 can be constructed apart or separate from parcel compartments 8 such that the doors can be easily sized and shaped to correspond to the compartments.

Referring to FIG. 1A, each kiosk 2 is associated with a computer 18. Computer 18 can comprise a computer screen 20 and other accessories (e.g., a keyboard, a mouse, a signature pad, etc.) that are electronically connected to computer. In preferred embodiments, computer 18 comprises software permitting computer screen 20 to operate as a “touch” screen. Touch screens are typically computer screens that are sensitive to pressure applied thereto. As such, a touch screen permits information to be input into computer 18 and/or an, for example, stored in an associated computer database, when a user, consumer, etc., touches the computer screen.

Computer 18 permits input, storage, and retrieval of information for access by customers, delivery companies, and other users at kiosk 2. The information can include any information used in categorizing and/or accessing parcels to be stored in the kiosk. Typical information can include kiosk information such as kiosk location, customer information such as the customer's name and address, product information such as the UPC code and merchandise brand names, delivery company information such as company name and shipping schedules, and the like. Information of the kind described above is exemplary and for illustrative purposes only. In short, any type of information related to “parcel package related or tracking information” and “parcel recipient pertinent information” is contemplated by the invention.

Preferably, computers 18 can be mounted on each end of the kiosk to provide customers, delivery companies, and other users with multiple locations for accessing the computers within each kiosk 2. Also, as shown in FIG. 1A, scanner 22 can be incorporated into kiosk 2 and associated with computer 18. Scanner 22 is capable of reading identifying indicia (e.g., UPC codes) to identify parcels for pick-up and/or delivery. One scanner of the kind contemplated for use with the present invention can be obtained from Hand Held Products, Inc., (a Welch Allyn affiliate), of Skaneateles Falls, N.Y. Computer screen 20 and scanner 22 can control access to parcel compartments 8 by activating or deactivating locking system 16 associated with doors 14 of kiosk 2. Thus, consumers, delivery companies, and users are supplied with a variety of options for accessing parcel compartments 8.

In addition, one or more cameras 15 (FIG. 3) can be positioned on kiosk 2. Such cameras can comprise digital cameras, motion sensitive cameras, and the like. Typically, motion can be detected when a compartment is opened and/or closed, and therefore the cameras can be activated. The cameras, and associated recorders (not shown), can be used to capture and record an image (e.g., of an individual delivering or picking-up a parcel) to verify that a parcel has in fact been placed inside or removed from a parcel compartment 8 within kiosk 2. One camera of the kind contemplated for use with the present invention can be obtained from X10, Inc., of North Las Vegas, Nev. Accordingly, kiosk 2 can be monitored continuously (i.e., 24 hours a day) using cameras and/or recorders to capture and record images.

It is further contemplated that an alarm system can be associated with kiosk 2. If an unauthorized entry is made into one or more parcel compartments 8, or if compartments are damaged or vandalized, the alarm system can activate and release a notification such as a sound or signal. In preferred embodiments, the notification can alert and/or trigger a response from appropriate personnel. Therefore, if kiosk security, functionality, or even its overall appearance has been breached, compromised, or in some other way altered, “off-site” (i.e., a site that is removed or otherwise away from the individual kiosk) appropriate personnel are notified. In one embodiment (not shown), a centralized, off-site information data center monitors kiosk security to ensure that only authorized use of the kiosk takes place.

In one embodiment, kiosk 2 can be climate controlled. As such, each parcel compartment 8 within kiosk 2 can be either heated or cooled as required, depending on the product, package, or parcel being delivered. Climate-controlled compartments permits kiosk 2 to accommodate the delivery of items such as groceries, frozen foods, perishable and/or fungible parcels.

Kiosk 2 can comprise one of numerous kiosks that are interconnected (also called “networked”) using the Internet and/or the Web, a satellite or telecommunications system, and the like. Each kiosk 2 can be monitored from a central location. Networked kiosks can create a logistics partnership between delivery companies, retailers, e-tailers and consumers. Networked kiosks can significantly reduce delivery costs, improve parcel delivery and/or pick-up, enhance parcel security, and the like. For example, retailers and e-tailers, and the delivery companies that deliver goods, can be sufficiently confident that the goods have indeed been appropriately “delivered” (i.e, the products have reached an appropriate, secure, and final destination with respect to the consumers and/or users).

In one embodiment, the networked kiosks can be operated as follows:

Signing Up for an Account

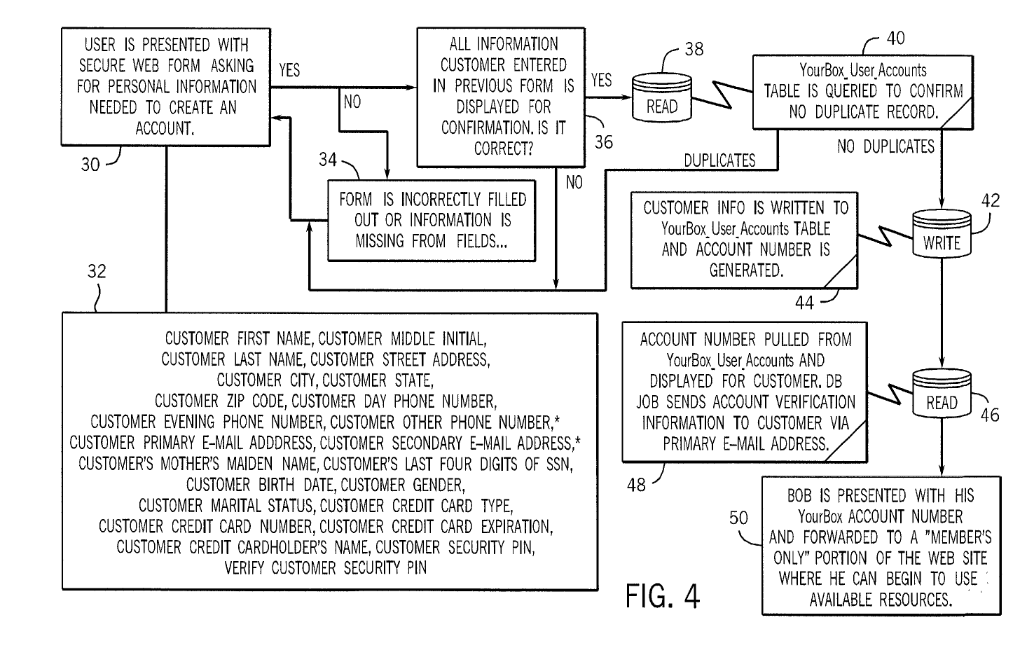

As illustrated in the flow diagram of FIG. 4, a user (i.e., a consumer, a delivery company, a retailer, or e-tailer) can first request an account associated with a membership plan or service. Users preferably can purchase periodic memberships (also called subscriptions) to the parcel service for a specific time period, such a day, a week, a month, a year, or otherwise. To request an account, the user locates an available graphic user interface (GUI), such as a web page on the Web or a page displayed on a touch-screen configured computer screen 20 at kiosk 2.

In one embodiment, as shown in box 30, the user is presented with a secure web form requesting information. A non-exhaustively list of information that can be requested is illustrated in box 32 and includes, for example, the customer's name, address, phone number, e-mail, and the like. Marketing data, such as age, gender, and marital status can be collected. Financial data such as credit card information can be requested to ensure payment. Of particular importance is payment and security related information. Payment information generally includes a credit card number, type, and expiration date. Security information typically comprises the maiden name of the customer's mother, a personal identification number (PIN) that the customer would like to use for access purposes, the customer's social security number (SSN), and the like.

If the secure web form is incorrectly completed, as noted in box 34, the user is once again prompted by the secure web page form of box 30 and encouraged to properly and/or completely fill in the form.

If the secure web form has been appropriately competed, and the information in box 32 supplied, the information can be displayed to the user at the GUI for confirmation of accuracy, as noted in box 36. If the user responds to the request for confirmation with a “NO” or negative answer, the user is prompted by the secure web page form, at box 30, to revise or edit the information supplied, to complete box 32.

If the user confirms the accuracy of the information entered into the secure web page, the information is read by computer 18 as illustrated by box 38. In preferred embodiments, computer 18 searches associated databases (or other memory) for duplicate information, as depicted in box 40. If duplicate information is located within the databases, the customer can once again be prompted with the secure web page of box 30. In such situations, the customer can enter new or revised information to set up a new or additional account. In another embodiment, the detection of duplicate information can indicate to computer 18 that the customer has already established a viable account. In such a case, although not shown on FIG. 4, the computer, via the secure web page, can request a customer security pin, or other information, (box 32) from the customer. If this “security” information is provided, the customer can be reminded, in a variety of ways, about the existing account and, in some cases, provided the existing account number.

If computer 18 detects no duplicates within the databases, the computer writes the information (box 32) to one or more associated databases as illustrated at box 42. After writing (i.e., storing) the information, an account number is generated by computer 18 for the user, as shown at box 44. As illustrated by box 46, the account number is read by the GUI, and then displayed for the customer, as outlined in box 48. In preferred embodiments, computer 18 and/or the database generates a notification (e.g., an e-mail message) and sends that notification to the user for verification of the newly registered account. In one embodiment, computer 18 employs the Web, a satellite, or other telecommunication systems to deliver the notification.

As shown in box 50, upon presentation of the account number, the customer is forwarded to a further web page where services and/or resources relating to the networked kiosks can be displayed. This “further” web page is typically only accessible by those users having existing, viable accounts. By establishing an account with the kiosk network, and visiting the further web page, the customer is entitled to access parcel compartments 8 within kiosk 2 and/or utilize other network services. Thus, the customer can make purchases and have parcels delivered to a designated kiosk.

Purchasing a Product

Upon ordering a product from a retailer, and especially from an e-tailer, a consumer will typically be prompted with a request for a shipping or delivery address so that the product can be delivered. Conventionally, the consumer would provide a home or business address for delivery. Thereafter, the retailer or e-tailer would supply the delivery company with the ordered product and the delivery address. As noted herein, this system of delivery is inefficient and inconvenient.

As an alternative, instead of providing a home or business address when ordering products for delivery, the user of the networked kiosks can simply provide the assigned account number. By providing the account number, the retailer, e-tailer, and resultantly the delivery company, recognize the user and are notified that delivery is to be made to a particular kiosk 2 in the network of kiosks. The account number performs as a “key” which unlocks all or a portion of the stored information in the user's account. As such, the delivery company is instructed to deliver to a kiosk 2, which can have its own established street address or post office box, in lieu of, or as opposed to, the previously utilized home or business address. Optionally, the user may be asked to confirm certain of the contact information by providing a piece of security information. Also, the user can optionally be prompted to provide some other informational identifier, such as a login name and/or password.

If upon ordering product from a retailer or e-tailer, the consumer does not have an existing account, the consumer can be momentarily diverted from the product transaction to set up a new account, as described above. When the account is activated, the user can be returned by the retailer or e-tailer to the transaction. Thus, accounts can be established either before or during a product purchasing transaction.

In preferred embodiments, when the product is ordered with an account number, or when the delivery company receives the packaged product (i.e., the parcel) from the retailer or e-tailer, an electronic notification (or intention of delivery message) can be sent to the computer and/or database associated with the networked kiosks. For example, a tracking identification number (tracking ID), a package identification number, and/or a UPC code, the unique customer account number, and the like, can be sent. Likewise, other information such as the size of the parcel, weight of the parcel, whether the parcel contains a fragile product, any climate control needs of the product, the sender of the product, and the like, can be included. As such, kiosk 2, and the network of kiosks, is “forewarned” of the product's arrival. The electronic notification can be sent in to computer 18 via the Internet, phone lines, a satellite, or telecommunications system.

In another embodiment, upon ordering a product, the notification can be immediately sent to a customer and indicate an assigned parcel compartment at a particular parcel kiosk, an anticipated delivery date, directions to the kiosk, a contact phone number of delivery company, parcel identification numbers, and the like. This notification can be sent via e-mail, automated voice response, and the like. Further, customers can then be notified of a prescribed amount of time (for instance, one or two weeks—determined for instance by the level of kiosk use, or standard corporate policy) to pick up a parcels at the specified kiosk without incurring further charges. If a customer is tardy or overdue in making a pick-up, rather than returning the package some other location, holding charges can be added (e.g., for each day after the prescribed period has lapsed). This information can also be included in the notification.

Upon receiving the electronic notification, computer 18 can utilize the information in a multitude of ways. Computer 18 can store the information in one or more databases, use the notification to trigger a reply to the delivery company, retailer, or e-tailer, and the like. Possibly most importantly, however, computer 18 can use the electronic notification to assign one or more parcel compartments 8 in the kiosk 2 chosen by the user. Thus, the network of kiosks 2 can ensure adequate parcel compartments are available for drop-off of the parcel by the delivery company. In the event that parcel compartments in a chosen kiosk 2 are full, alternate kiosks, as chosen by the user or computer 18, can be enlisted to receive the parcel and provide a locale for pick-up by the user. In a preferred embodiment, users can be asked to provide a plurality (e.g., three) acceptable kiosk locations for alternate delivery.

Now that the packaged product, or parcel, has been relinquished to the delivery company with the kiosk delivery address, the delivery company can complete transport the parcel to the kiosk for storage until delivery, as outlined below.

Delivering a Parcel to a Kiosk

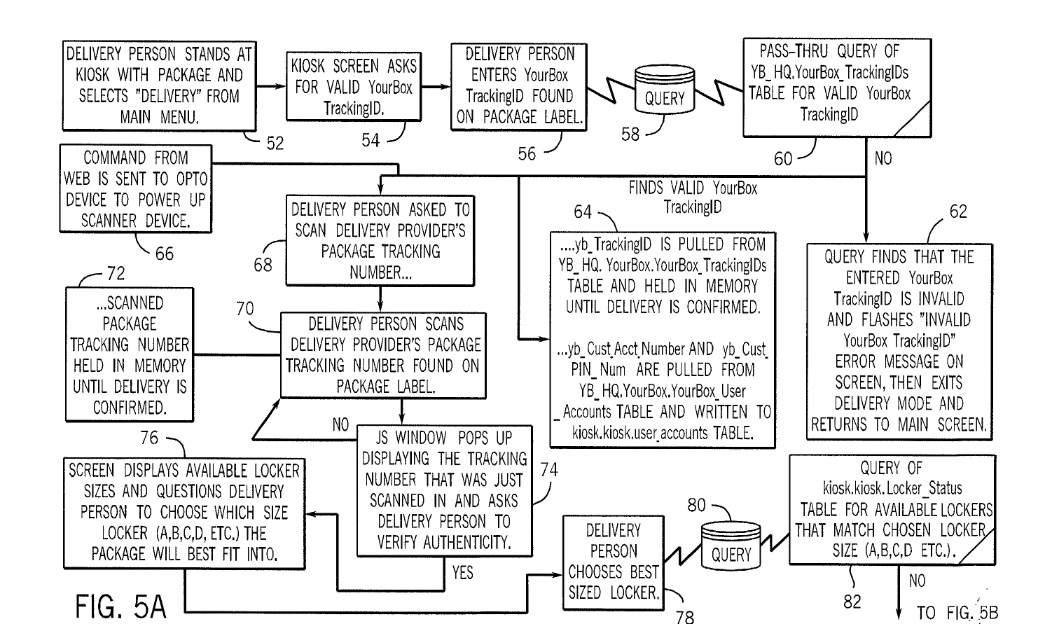

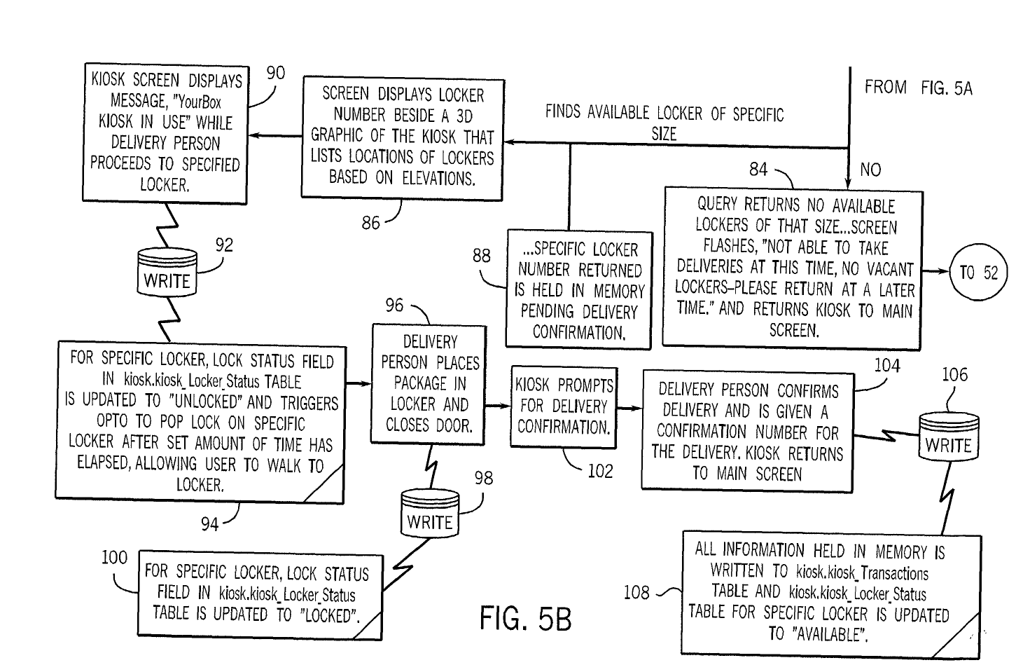

As illustrated in the flow diagram of FIG. 5, a delivery company and/or person can deliver a parcel to a chosen kiosk for secure storage until pick-up by the user. In a preferred embodiment, as illustrated in box 52, a delivery person has arrived at a chosen kiosk with a parcel. Using computer screen 20 (or the keyboard, the mouse, or other GUI feature), the delivery person selects “Delivery” from the “Main Menu” of available options. Thereafter, computer screen 20, associated with computer 18, prompts the delivery person for the tracking ID number, as shown in box 54. The delivery person, preferably using a “touch screen” equipped computer screen 20 or scanner 22, accommodates the request as noted in box 56. Although scanning is described and preferred, any method of data entry, including magnetic strip, smart card, or other data entry methods, is contemplated.

Once computer 18 receives the tracking ID number, the computer queries one or more associated databases, as depicted in box 58, to determine in the proffered tracking ID number is valid, as noted in box 60. If computer 18 finds that the tracking ID number is invalid, as illustrated in box 62, a warning and/or error message is displayed on computer screen 20. Thereafter, computer 18 returns computer screen 20 to the Main Menu display.

If computer 18 determines that the tracking ID number entered is valid, the tracking ID number is logged into memory until the entire delivery process, including pick-up of the parcel by the user, is completed, as shown in box 64. In a preferred embodiment, scanner 22 is activated, as noted in box 66, and the delivery person is further prompted to scan in the delivery company's tracking ID number (e.g., UPS's in-house tracking number) as shown in box 68. As box 70 indicates, the delivery company's tracking ID number is scanned using scanner 22. The company-specific information is then stored within computer 18 and/or one or more databases until the entire delivery process is completed, as noted in box 72. In some embodiments, the delivery person can be asked to confirm the company's tracking ID number for accuracy as illustrated in box 74. If the number is not accurate, scanning is repeated as previously performed in box 70. By scanning in both a tracking ID number, as well as the delivery company's tracking ID number, a cross-reference of information between the delivery company and the network kiosks 2 can be maintained regarding delivery of the parcel.

Next, as shown in box 76, computer screen 20 displays a list of available locker sizes and prompts the delivery person to choose a size for compartment 8. In preferred embodiments, the differently size compartments 8 can be identified with a compartment identifier (e.g., A, B, C, D) for identification, organization, and the like. The best-sized compartment 8 (i.e., a size sufficiently greater than the parcel, perhaps a climate controlled compartment, and the like) is selected by the delivery person as noted in box 78. Selection can be accomplished by using the “touch-screen” equipped monitor, the keyboard, the mouse, or like inputting devices. In a preferred embodiment, computer 18 can retrieve sizing information directly from the scanned tracking ID number, delivery company's tracking ID number, and the like when scanner 22 is utilized. In these embodiments, computer 18 is capable of suggesting and/or automatically selecting the compartment size.

After compartment size is determined, a query is performed by computer 18 and/or the database as shown in box 80. As box 82 depicts, the query is undertaken to access information regarding compartment status, availability, and the like, for the selected compartment. If no compartment 8 of any size is vacant in the entire kiosk 2, a warning or error message is displayed on computer screen 20 and the user is returned to the Main Menu as taught by box 84. Thus, with respect to the flow diagram of FIG. 5, the user is routed back to box 52 (or another like box) where the Main Menu is displayed. In other embodiments (not shown), the delivery person can be directed to another kiosk that has been chosen for alternative delivery by the customer (e.g., one of the three in an above example), can be directed to the nearest kiosk to the originally selected kiosk, the next nearest kiosk to the customer's home, the next nearest kiosk to the customer's business, the nearest available or vacant kiosk, and the like. In these embodiments, directions can be provide to the delivery driver, notifications (electronic or otherwise) can be sent to the customer, the delivery company, the retailer, the e-tailer, etc.

If, however, an available compartment meeting the criteria for the selected compartment is found during the query, computer screen 20 displays the compartment information, such as the compartment identifier, as noted in box 86. In preferred embodiments, the display of compartment information can include the location of the compartment relative to the kiosk, the elevation of the locker, the lockers properties, and the like. As illustrated by box 88, the compartment identifier is stored in computer 18 and/or one or more databases pending the confirmation of delivery (i.e., transfer of possession to the receiving customer or consumer).

As shown in box 90, as the delivery person is proceeding to the selected compartment, computer screen 18 displays a message indicating kiosk 2 is in use (i.e., temporarily unavailable). Status information regarding the selected locker is updated, and the updated information is written (or stored) in computer 18 and/or one or more of the associated databases as shown in box 92. Particularly, as illustrated in box 94, the status information includes the notation that the selected compartment has now been “unlocked.” Unlocking of the selected compartment is performed by electronic locking and releasing system 16, as earlier described. With the selected compartment “unlocked,” the compartment is capable of receiving the parcel or package being transported by the delivery person.

In a preferred embodiment, when the compartment is “unlocked,” a digital camera can take an image or series of images (for example, of the side of the kiosk that is being used) to confirm that a parcel has been placed in the compartment. These images can be stored in computer 18 and/or one or more associated databases. For purposes of security, placement of the parcel within the compartment can be required within a prescribed amount of time (e.g., within thirty (30) seconds of the compartment opening). If the amount of time is exceeded, the compartment can be automatically “locked,” a warning or notification can be sent to the network of kiosks, a warning or notification can be sent to the delivery company, and the like.

Upon reaching the selected compartments, the delivery person opens the unlocked door 14 of the selected compartment. Depending on the configuration of the specific compartment, the delivery person slides all or a portion of the compartment outwardly, opens a lid on the compartment, etc. As shown in box 96, the delivery person places the parcel within the selected compartment and closes door 14. Once door 14 is closed, the electronic locking and releasing system 16 is activated to secure the door and the stored status information is updated as noted in box 98. As depicted in box 100, the locker status information stored in memory now indicates that the compartment is “locked.”

At this point, as seen in box 102, the kiosk, via computer 18 and computer screen 20, prompts the delivery person for confirmation that the parcel has been placed in the selected compartment. Using any of the available input devices, the delivery person can make the appropriate confirmation and receive a delivery confirmation number, and as shown in box 104. The confirmation number, as well as the confirmation, can be written to computer 18 and/or one or more associated databases, as indicated in box 106. As noted in box 108, the written information can be retained until pick-up by the customer and the status information can reflect that a parcel is occupying the compartment. In other words, the status information can note that the compartment is now “unavailable.” The kiosk can return computer screen 20 to the Main Menu (box 104), as first described in box 52. If confirmation is not received (box 104), numerous security and/or fail-safe policies, which are not detailed herein, can be undertaken.

The parcel has now been successfully delivered and is ready for retrieval (i.e., pick-up) by the customer or consumer who purchased it. In preferred embodiments, the successful delivery can again trigger a notification, having a variety of information contained therein, being sent to a user, a customer, a delivery company, a retailer, an e-tailer, and the like.

Retrieval of a Parcel

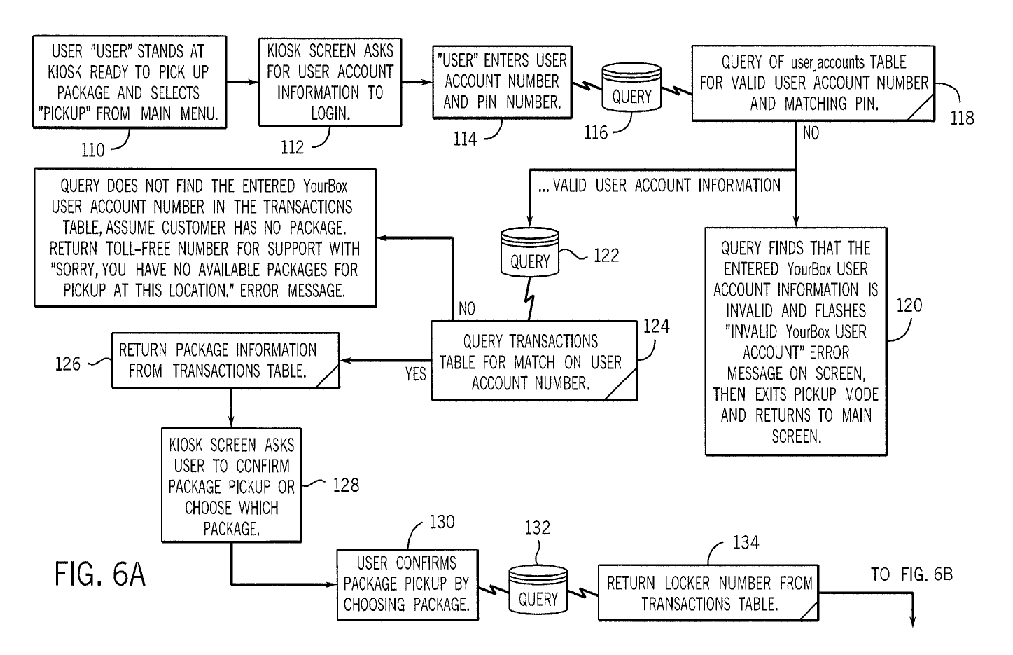

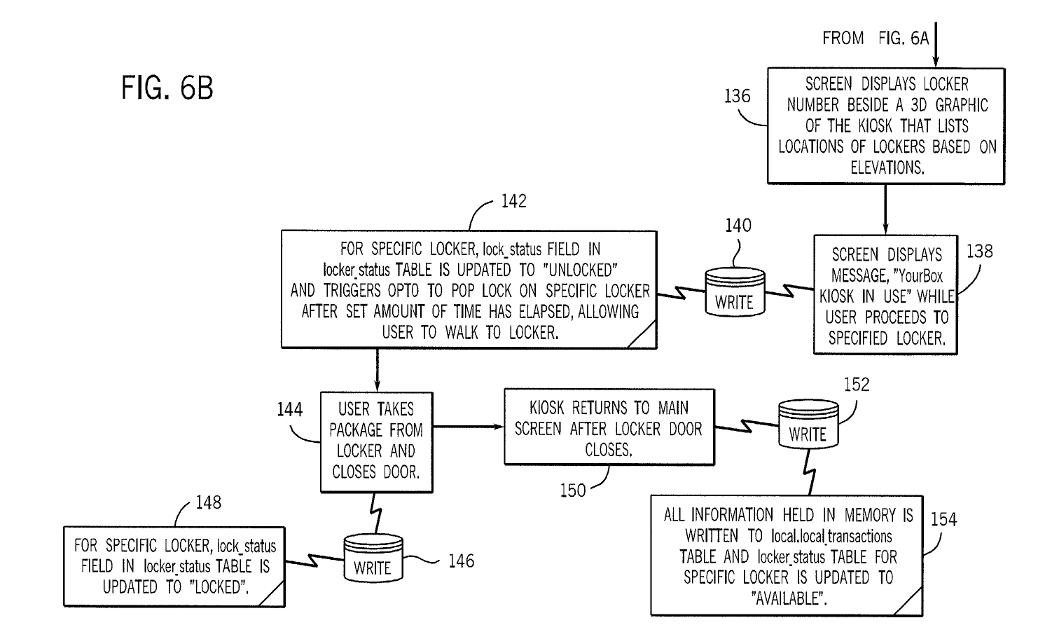

As illustrated in the flow diagram of FIG. 6, a user, typically a customer or consumer, can retrieve the delivered parcel from kiosk 2. In a preferred embodiment, as illustrated in box 110, the customer has arrived at the chosen kiosk where the parcel has been delivered and stored.

Kiosk 2, by virtue of computer 18 and computer screen 20, prompts the customer to supply identification information, as noted in box 112. This information can comprise the account number that has been assigned to the customer, a login name, a password, a personal identification number (PIN), a confirmation number received by e-mail, and the like. As before, this information can be entered into computer 18 by utilizing a “touch-screen” equipped computer screen 20, scanner 22, the keyboard, the mouse, and the like. Also, it is contemplated that any of the above listed information can accessed and used by inserting a smart card, credit card, debit card, or the like into an associated device. Likewise, other forms of personal recognition devices are contemplated.

In a preferred embodiment, as illustrated in box 114, the customer (or other user) enters their assigned account number and a PIN. Upon receiving this information, computer 18 performs a query of one or more databases as identified in box 116. The query attempts to match the account number and pin number entered by the customer with the information stored in the computer 18 and/or databases to determine if the account is valid, has been paid, and the like, as shown in box 118. If the result of the query finds that either the account number or PIN is invalid, a warning or error message is displayed on computer screen 20, as depicted by box 120. The identification process is then renewed by once again displaying the Main Menu as found in box 110. Thus, a correct or revise account number and/or PIN can be entered to proceed with the retrieval process.

If the query finds that the account is valid, and the PIN is correct, a further query can be performed, as noted in box 122. The query attempts to match transactions, deliveries, waiting packages, and the like, with the user's account information as described in box 124. If the query is unsuccessful, the customer can be notified that there is no parcel waiting for them at that kiosk (or any other kiosk) or the user can be directed to a help line, as shown in box 126. If, however, the query succeeds in finding matching package and/or delivery information within storage or memory, the information can be accessed by computer 18 as illustrated by box 126. When the information is accessed, computer screen 16 prompts the customer to confirm that they are retrieving a parcel, confirm which parcel if there are more than one, and supply other information if needed as shown by box 128. As noted in box 130, the customer confirms that parcel pick-up is intended and selects the appropriate parcel.

Thereafter, a further query to associate the appropriate parcel with the parcel's location within the kiosk (i.e., the compartment number, etc.) is performed as indicated by box 132. After the query is completed, the location information is recouped from computer 18 and/or one of the databases (box 134) and that information is displayed for the customer, as noted in box 136. In preferred embodiments, the displayed information includes a three-dimensional map of the kiosk highlighting the parcel's location within one of the compartments along with the compartment number. As the customer proceeds to the appropriate compartment to retrieve the stored parcel, computer screen 20 displays a message indicating that the kiosk is being used, and therefore, temporarily unavailable as shown in box 138.

Next, computer 18 writes information to the database, as indicated by box 140, that the compartment with the stored parcel is being unlocked. Thereafter, computer 18, employing locking and release mechanism 14, “unlocks” the compartment to which the customer is visiting (box 142). In preferred embodiments, the lock on the particular box can be activated to “unlock” the compartment after a pre-determined amount of time has elapsed. The pre-determined amount of time affords the customer time to travel to the compartment and prevents a compartment from being “unlocked” without a customer is close proximity. In one embodiment, the customer can, for example, have 30 seconds to open the compartment door before it will re-shut and/or re-lock automatically. Thus, the amount of time acts as a security feature for the kiosk. Although not shown in the flow diagram of FIG. 6, cameras can again be activated, as earlier described, to capture images of the customer using the kiosk and/or retrieving the package from the compartment. These images can be recorded and maintained within one or more databases as documentation that the parcel was retrieved, was retrieved by a particular person, and the like. Again, the cameras can provide a security benefits such as eliminating or reducing claims that parcels were never received, damaged, and the like.

From the now “unlocked” compartment, the customer retrieves the stored parcel as noted in box 144. As indicated in boxes 146 and 148, after the package is retrieved, the compartment is once again locked and the status information on the compartment is updated to indicate that the compartment is locked and vacant. Of particular advantage, as described above, it the ability of parcels to be picked-up at the convenience of the customer since the kiosk is operation 24 hours a day, and seven days a week.

After the customer has retrieved the stored parcel, and the compartment re-locked, the computer within the kiosk returns the computer screed to a Main Menu screen as detailed in box 150. At this point, the computer and/or computer screen within the kiosk is available for the next customer or delivery person. Within the network of kiosks, the computers and associated databases are updated to reflect that the previously occupied compartment is now available once again, as noted in boxes 152 and 154.

Also, it should be noted that a delivered parcel can be returned using the same delivery kiosk and system. Such a return process can be extremely efficient if scanner 22 is incorporated in the return process. All of the information imbedded or associated with the tracking ID's, UPC codes, can be utilized upon being scanned such that efficient returns are encouraged.

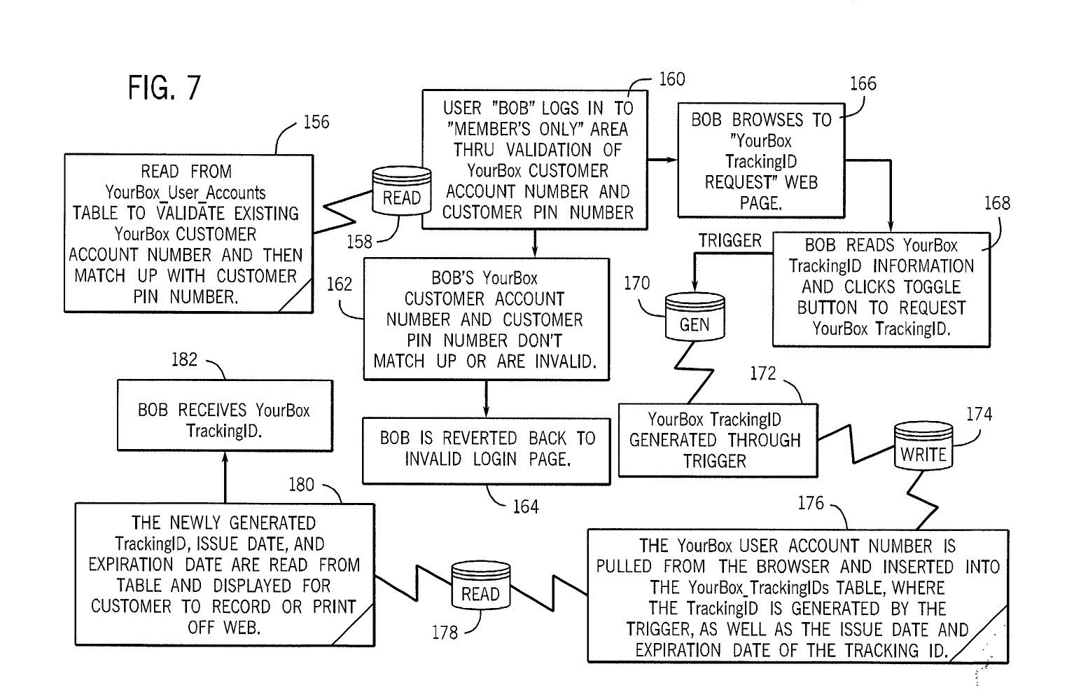

In another embodiment, as illustrated by the flow diagram of FIG. 7, “tracking” of a parcel can be accomplished by the network of kiosks using a tracking ID system. As used herein, tracking generally comprises a system for permitting a user, retailer, e-tailer, delivery person, or a host of other parties, to locate a parcel anywhere along the delivery route. The delivery route extend as far as a retailer or e-tailer's shelf or warehouse up to and including ultimate retrieval by a customer or other user. In other words, no matter where a parcel is, it can be located.

In the embodiment of FIG. 7, as outlined in boxes 156 and 158, customer information (e.g., an account and PIN number) is input at a GUI, such as a kiosk, and read to validate the customer information (i.e., determine if the customer possesses an active account). Once the customer information is validated, the customer (or other user) is “logged-in” to a “members-only” portion of the networked kiosk system as illustrated by box 160. Alternatively, as indicated in boxes 162 and 164, if the customer information cannot be validated, the customer is returned to a previously displayed page such as a login page or the Main Menu.

Within the members-only services routine and/or displays, the customer can selectively request that a particular parcel be tracked (box 166). Upon requesting parcel tracking, tracking ID information is requested and input by the customer using any of the input devices described herein as explained in box 168. Preferably, the tracking ID number can be entered by scanning one or more UPC codes, tracking ID numbers, or the like. After the information is input, the tracking ID system is triggered and a tracking ID number is generated (boxes 170, 172). As noted in box 174, the generated tracking ID number is written to storage within computer 18 or one of the databases. The tracking ID number is processed (box 176) such that the generated tracking ID number is accompanied by an issue date of the tracking ID request, an expiration date of the tracking ID number, and other like information. This “tracking” information represents the location of the parcel. The tracking information is read by computer 18 and displayed for the customer or other user (box 180). Thereafter, the customer can print the tracking information, send the information to an e-mail account, or simply view the information on the computer screen (box 182).

Using the tracking system as described above, customers and other users can determine where parcels are within the delivery route. As such, pick-up times can be anticipated, orders can be canceled before delivery is completed, and the like.

Further, due to the size and ease of construction of kiosks 2, the kiosks can be conveniently located, or for that matter, re-located. More specifically, the kiosk can be conveniently located near to places where people frequently congregate or traffic past (e.g., entrances to parking lots and neighborhoods, office buildings, apartments, park and ride lots, and the like). As such, the kiosk fulfills the secure storage needs of users so as to facilitate the pick up and/or delivery of parcels near the locations where the users live or work (or simply, during times when such users are performing routine chores or errands).

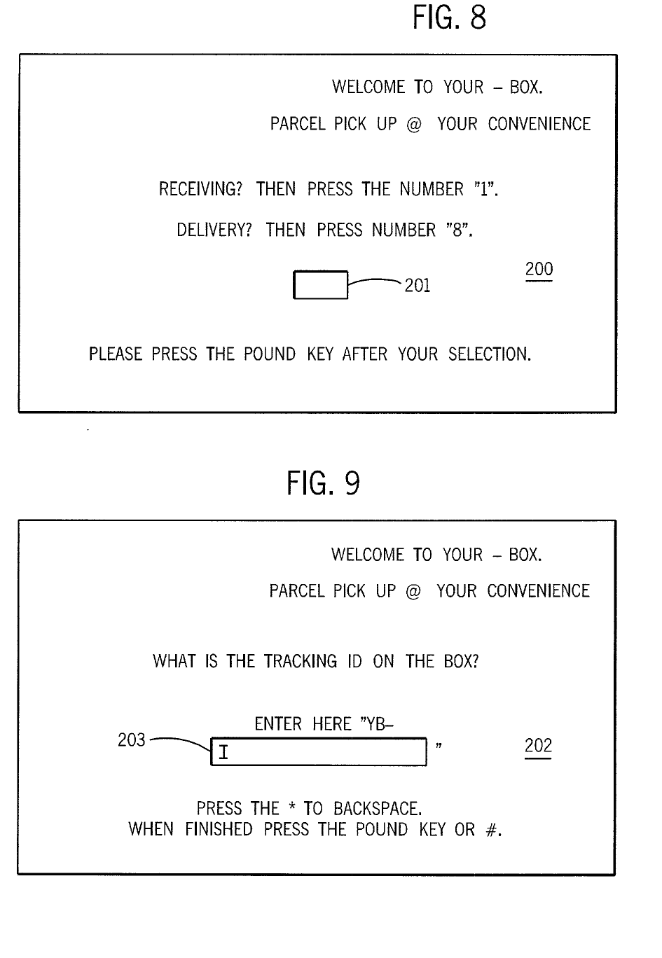

FIG. 8 illustrates one exemplary GUI used in the computer 18 (FIG. 1). In this illustration, screen 200 queries whether the user is performing a delivery or pick-up (receiving) function. As distinguishing between delivery and pick-up is a key piece of information required prior to performing additional functions, screen 200 may be considered, in a preferred embodiment, a default or initial screen. The user inputs an appropriate data (also called “pertinent information”) corresponding to the delivery or receiving functions at, as shown, location 201.

FIG. 9 illustrates an example of a first query screen used in a delivery. It is now known that a delivery is being performed (the user having selected that function in initial screen 200 of FIG. 8). Screen 202 tasks the user with entering a tracking ID, or other tracking indicia relating the parcel being delivered, so as to ensure that the user is a bone fide delivery professional present to deliver an authorized package (i.e., a package that will be subsequent picked-up/received by an authorized parcel recipient). Although the tracking indicia can be entered from a keyboard, this information need not be entered manually. For example, in order to assist the delivery person, a data entry device, such as a scan gun, wand or light pen can be used to scan the ID from a barcode directly from the package, or a package list, such that the appropriate ID is automatically entered into the appropriate screen location 203.

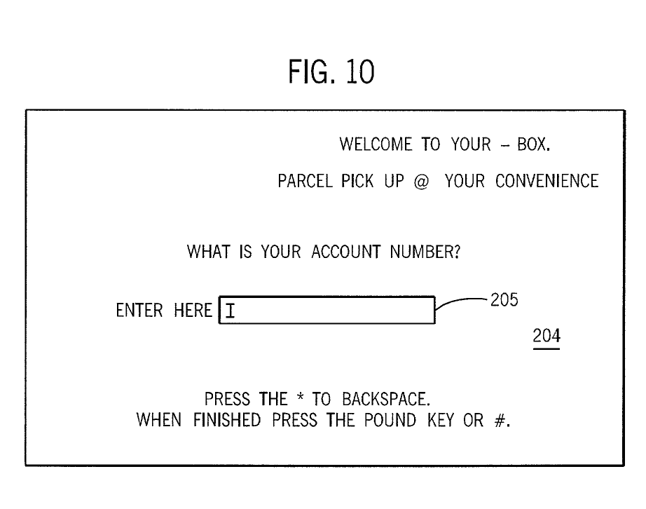

FIG. 10 illustrates an example of a first query screen used in a pick-up or receiving functionality. It is now known that a pick-up is being performed (the user having selected that function in screen 200 of FIG. 8). Screen 204 queries the user to enter the account number or other pertinent information relating the user so as to ensure that the user is the addressee or someone authorized to act on the addressee's behalf. The account number or other pertinent information can be entered, into screen location 205, from a keyboard or, in order to better assist the user, in automated fashion (e.g., smart card, biometric solutions, etc.).

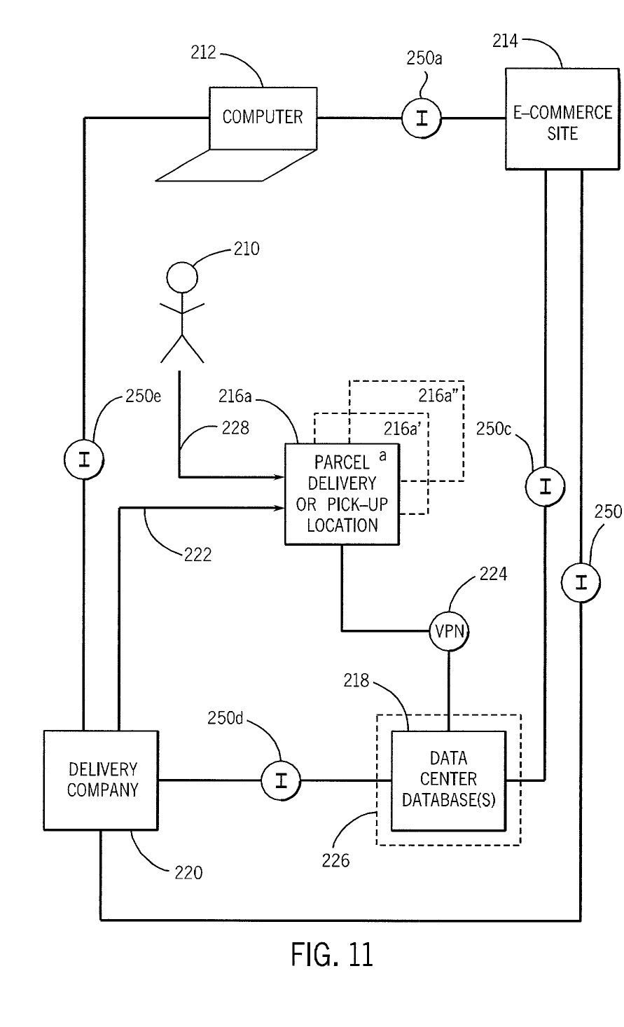

FIG. 11 is a schematic diagram of one embodiment of a parcel delivery and pick-up solution according to the present invention. A typical online product ordering, delivering and pick-up scenario first requires user 210 to access, via computer 212 (e.g., a workstation, a laptop, a handheld device such as a Palm™ pilot, a cell phone, etc.) e-commerce site 214 to as to initiate a product order or transaction. While logged onto the website, user 210 selects a product to be ordered and, before, during or after such selection, provides, at the website, address (e.g., e-mail address, pick-up address, etc.) information. Still at the website, the user can select a desirable pick-up location 216a from a number of potential locations (216a′ and 216a″) provided. Alternatively, the specific pick-up location 216a can be determined or assigned by the website in an automated fashion, requiring no selection by the user, but only the entry of a pick-up address. In one embodiment, the location is assigned using information stored in a back office or remote database(s) 218, with the assigned location selected based on proximity to the desired pick-up location. As a practical matter, locations 216a-216a″ are representative only and any number of similar locations can be included as part of the network. It is contemplated that site 214 can be, in addition to a website, a brick and mortar (i.e., physical) store or retailer, a catalogue-type retailer, or a television retailer (e.g., QVC™).

The e-commerce site notifies the delivery service or company 220 (e.g., U.S. Postal Service, UPS™, FedEX™, CF™ and the like) that a parcel requires shipment and delivery to the specified delivery location 216a and the location is provided to the service or company. Physical parcel delivery then can take place, as indicated by connection 222. Data center 218 can be used to monitor, preferably via a virtual private network 224 (“VPN”), delivery (and subsequent pick-up) of the parcel. Security precautions, such as firewall 226, can be used to protect databases in the data center 218. Once proper delivery has occurred, notification can be sent from data center 218 to site 214, which in turn can forward such notification to computer 212 (e.g., via e-mail). User 210, in an alternative embodiment, can access parcel tracking information directly from the shipper 220 via computer 212. Physical pick-up 228 by user 210, or the user's authorized agent, can then occur. Connections 250a-e are represent Internet connections (e.g., DSL, T1, cable, satellite, etc.), including e-mail.

The present invention has been described as a particular system. However, other forms and constructions of the present invention may be used. For example, the present invention may be considered and may be implemented as: parcel storage system, a method of securing a parcel for delivery and retrieval, a secure product procurement method, a method of receiving parcel packages, a method of sending parcel packages, a method of online delivery to a kiosk, a delivery network, an Internet delivery system, a method of providing delivery data for a parcel package, a delivery kiosk system, a Graphic User Interface (GUI) for a delivery kiosk system, a final mile delivery solution, a final mile solution for transporting goods to an end user, a method of delivery for use by a shipping service, a parcel delivery system for use by a shipping service, a parcel delivery kiosk for use by a shipping service, a secure storage locker for picking up parcels delivered to the locker by a shipping service, a secure, e-commerce transportation, information, and logistics solutions for at least one of delivery and pick-up of parcel packages, as well as an online shipping solution, among others.

Despite any methods being outlined in a step-by-step sequence, the completion of acts or steps in a particular chronological order is not mandatory. Further, elimination, modification, rearrangement, combination, reordering, or the like, of acts or steps is contemplated and considered within the scope of the description and claims.

Where the invention has been described with reference to illustrative embodiments, it is recognized that equivalents, alternatives, and modifications, aside from those expressly stated, are possible and within the scope of the appending claims. Such will be apparent to those persons who are skilled in the art upon reference to this description.

What is claimed is:

1. An internet-based system for parcel delivery and pick-up, the system comprising:
a parcel recipient accessible computer from which a parcel recipient can access over an internet a website to initiate a parcel delivery via a product order;
a kiosk located at a parcel delivery and pick-up location, the kiosk capable of storing the parcel, the kiosk electronically connected to a computer, the computer for use in storing, manipulating and retrieving both parcel recipient pertinent information and parcel delivery tracking information; and
a central data system for receiving the parcel recipient pertinent information and parcel delivery tracking information from the computer connected to the kiosk and, based on that information, transmitting parcel related data to at least one of the delivery service, the parcel recipient and the website;
wherein the parcel can be delivered to the kiosk using the delivery service and the parcel can be pick-up by the parcel recipient.

2. The system of claim 1 wherein the website is one of a retailer and an e-tailer website.

3. The system of claim 1 further comprising a plurality of kiosks connected to the central data system.

4. The system of claim 1 wherein the parcel recipient pertinent information received at the central data system is used to ensure that the parcel recipient is at least one of an authorized parcel recipient and an authorized agent of the authorized parcel recipient.

5. The system of claim 1 wherein the parcel related data transmitted to the delivery service ensures that the delivery service delivers the parcel to the kiosk at the parcel delivery and pick-up location.

6. The system of claim 1 wherein the connection between the parcel delivery kiosk and the central data system is a virtual private network (VPN).

7. The system of claim 1 wherein the parcel recipient is notified at the parcel recipient accessible computer that a parcel is ready for pick-up.

8. The system of claim 7 wherein the parcel recipient is notified via e-mail.

9. The system of claim 1 wherein parcel delivery and pick-up location is a location selected by the parcel recipient.

10. The system of claim 1 wherein parcel delivery and pick-up location is assigned via one of the website and the central data system.

11. A method of ensuring authorized parcel delivery and retrieval from a secure location, the method comprising:
assigning and storing parcel recipient pertinent information, secure location information, and parcel tracking information;
using the parcel tracking information for delivering of a parcel to the secure location;
using the parcel recipient pertinent information for retrieving the parcel at the secure location; and
using the stored parcel recipient pertinent information, secure location information, and parcel tracking information so as to monitor, via a computer network, the delivering and retrieving of the parcel thereby ensuring authorized parcel delivery and retrieval from the secure location.

12. The method of claim 11 wherein the assigning of the parcel recipient pertinent information and the secure location information occurs while a product is ordered from a website on the Internet.

13. The method of claim 11 wherein the assigning of the parcel tracking information allows tracking of the parcel while the parcel is in transit to the secure location and further allows delivery of the parcel at the secure location.

14. The method of claim 11 wherein the parcel recipient pertinent information allows the retrieval of the parcel at the secure location.

15. A method for accomplishing at least one of delivery and retrieval of a parcel, the method comprising:
providing a parcel storage kiosk, the kiosk comprising a structural framework, the framework capable of receiving and supporting a plurality of parcel storage compartments, each of the compartments having an interior capable of storing a parcel;
providing a computer system that is electronically connected to the kiosk, the computer system for use in storing, manipulating and retrieving pertinent information relating to a user and parcel tracking information;
issuing at least one identification code specific to at least one of the user and the parcel in determining whether the user may access at least one of the kiosk parcel storage compartments;
receiving the at least one identification code at the kiosk computer;
permitting access to at least one of the plurality of compartments based on the at least one identification code so that the user can accomplish at least one of authorized delivering and retrieving of the parcel.

16. The method of claim 15 wherein the kiosk and the computer system are monitored by a central database to ensure at least one of the authorized delivering and retrieving of the parcel, and the central database is connected to a global computer network.

17. A method of sending a parcel package comprising:
providing a kiosk for receiving and securably storing a parcel package, the kiosk including a computer;
providing a graphic user interface accessible at the computer for receiving parcel package related information;
receiving the parcel package related information through the graphic user interface;
making a portion of the kiosk available to securely store the parcel package based upon the parcel package related information; and
receiving the parcel package within the portion of the kiosk to securably store the parcel package.

18. The method of claim 17 wherein the making comprises computing an appropriately sized portion of the kiosk to receive the parcel package.

19. The method of claim 17 further comprising ordering the parcel package at a website using a pre-selected delivery address field to identify a particular delivery location corresponding to the parcel storage kiosk.

20. The method of claim 19 wherein the pre-selected delivery address field is filled with a suite number.

21. A final mile delivery solution comprising:
a plurality of kiosks, each of the kiosks comprising a plurality of compartments, each of the compartments being capable of storing a delivered parcel and comprising a door, each door permitting access to the compartment and including a locking system therein;
at least one computer in operational association with each of the kiosks, the at least one computer capable of accepting information and comprising a computer screen;
a database in operational association with the computers, the database capable of storing and recalling the information associated with use of the plurality of kiosks;
wherein a user of one of the plurality of kiosks inputs the information into the computer, the computer verifying the information, the computer actuating the locking system within the door to unlock the compartment, and the user retrieving the delivered parcel from the compartment.

22. The solution of claim 21, wherein the delivered parcel has been ordered by the user from a retailer.

23. The solution of claim 22, wherein the delivered parcel is released by the retailer to a delivery company for delivery.

24. The solution of claim 23, wherein the user provides the retailer with the location of the kiosk for delivery of the parcel.

25. The solution of claim 21, wherein the delivered parcel is delivered by the delivery company to one of the plurality of kiosks.

26. The solution of claim 21, wherein the delivered parcel is delivered to one of the plurality of kiosks at a user's request.

27. The solution of claim 26, wherein the user's request is submitted to at least one of the retailer and the e-tailer during a transaction where the delivered parcel is ordered.

28. The solution of claim 26, wherein the user's request is submitted to at least one of the retailer and the e-tailer at the time the delivered parcel is purchased.

29. The solution of claim 21, wherein the database stores one of a locked position and an unlocked position of the locking system.

30. The solution of claim 21, wherein access to the compartment is limited to a pre determined amount of time.

31. The solution of claim 30, wherein the predetermined amount of time is approximately thirty seconds, sixty seconds, or ninety seconds.

32. The solution of claim 21, wherein the computer screen functions as a touch screen for inputting parcel recipient pertinent and parcel tracking information.

33. The solution of claim 32, wherein input of the information into the computer is accomplished by the user operating the touch screen.

34. The solution of claim 21, wherein the database is associated with at least one of a satellite, an internet, an intranet, a world wide web, a phone line, an optical cable, a router, and a server.

35. The solution of claim 32, wherein the information comprises at least one of name, address, phone number, e-mail, age, gender, marital status, credit card number, credit card expiration date, credit card company name, maiden name, personal identification number, and social security number, parcel number, tracking ID number, delivery company tracking ID number, account number, access number, verification number, kiosk identifier, retailer name, e-tailer name, delivery address, kiosk location, and compartment number.

36. The solution of claim 32, wherein the information is input into the computer by at least one of a scanner, a touch screen, a mouse, a keyboard, a smart card, a credit card, a debit card, and a magnetic strip.

37. The solution of claim 27, wherein at least one of the user, a retailer, a e-tailer, a delivery person, and a delivery company receives an e-mail regarding the delivered parcel.

38. The solution of claim 32, where the solution further comprises one or more cameras associated with each of the kiosks.

39. The solution of claim 38, wherein each of the one or more cameras is associated with a recording device for recording images captured by the cameras.

40. The solution of claim 21, wherein the delivered parcel includes at least one of a bar code, a UPC code, a tracking ID number, a delivery company tracking ID number, an idicia associated with a retailer, and an indicia associated with an e-tailer.

41. The solution of claim 21, wherein the compartments are climate controlled.

42. The solution of claim 21, wherein the solution is operated twenty-four hours a day and seven days a week.

43. The solution of claim 21, wherein the user can retrieve the delivered parcel from within the compartment upon e-mail notification.

44. The solution of claim 21, wherein after the delivered parcel is stored within the compartment and the user is provided with a predetermined amount of time for retrieving the delivered parcel from the compartment.

45. The solution of claim 21, wherein each of the kiosks is capable of being secured to another kiosk or an adjacent structure.

46. The solution of claim 21, wherein each of the kiosks is capable of being modularly secured to one or more additional kiosks.

47. The solution of claim 21, wherein the solution further comprises an alarm system associated with each of the kiosks, the alarm systems providing security to the solution.

48. The solution of claim 21, wherein the delivered parcel can be tracked to determine the location of the delivered parcel at any given time.
